(19) United States
(12) Patent Application Publication
(10) Pub. No.: US 2004/0149401 A1
(43) Pub. Date: Aug. 5, 2004

(54) Flexible multi-link closure

(76) Inventor: Isaac Rinkewich, Hightstown, NJ (US)

Correspondence Address: JAMES & FRANKLIN, LLP, Suite 2915, 60 East 42nd Street, New York, NY, 10165, US

(21) Appl. No.: 10/353,257

(22) Filed: Jan. 30, 2003

(51) Int. Cl. E06B 3/06

(52) U.S. Cl. 160/235

(57) ABSTRACT

Each link of a flexible multi-link closure includes a cylindrical male member and a female member. The female member includes an open arcuate wall, in part defining a recess adapted to moveably receive the male member of an adjacent link. A part connects the members of each link in a fixed, spaced relationship at a distance approximately equal to the thickness of the wall of the female member. One edge of the wall of the female member is spaced from a line extending through the center points of the members by a distance approximately equal to half the length of the connecting part.

### CROSS-REFERENCE TO RELATED APPLICATIONS

NOT APPLICABLE

### STATEMENT REGARDING FEDERALLY SPONSORED RESEARCH ON DEVELOPMENT

NOT APPICABLE

### REFERENCE TO “SEQUENCE LISTING”

NOT APPLICABLE

### BACKGROUND OF THE INVENTION

Field of the Invention

The present invention relates to a flexible closure such as a shutter or tambour assembly formed of a plurality of interconnected links and more particularly to the structure of the links in a flexible multi-link closure that permits maximum flexibility while minimizing air and moisture permeability.

Various types of mobile and stationary enclosures such as utility carts, housekeeping carts, lockers, roll-up desks and windows have an opening which is closeable by a flexible interconnected multi-link closure such as a door, shutter and/or tambour assembly. The portion of the enclosure adjacent the opening is provided with opposing guide tracks or channels along which the ends of closure links can be moved in order to permit access to the enclosure interior.

Often, the guide channels have one or more abrupt bends or corners. It is therefore advantageous for the closure to be able to move around a relatively sharp curve, sometimes as great as a right angle. Further, the closure may have to coil around itself in a minimum space for storage. This requires that the closure be very flexible, with the adjacent links being formed so that they can pivot relative to each other about a minimum turning radius. At the same time, it is desirable to have the closure be as thin and light in weight as is possible.

Enclosures of this type are often used in environments where isolation of the enclosure interior from the environment is important. Accordingly, it is also desirable that the closure form a significant air and moisture barrier, while at the same time maintaining ease of operation such that the enclosure interior is easily accessible.

In general, those objects are achieved in my invention by utilizing a link for a flexible multi-link closure which has a unique structure. The link of my invention is formed of male and female members which are shaped and connected together in a way that permits adjacent links to move relative to each other such that the closure can travel around sharp bends in the guide channel, and at the same time, the links can be situated in a straight line so that the closure can travel along straight portions of the guide channel.

It is, therefore, a prime object of the present invention to provide a flexible multi-link closure capable of traveling around a sharp bend.

It is another object of the present invention to provide a flexible multi-link closure capable of moving along a straight line.

It is another object of the present invention to provide a flexible multi-link closure which forms an air and moisture barrier.

It is another object of the present invention to provide a flexible multi-link closure which is thin, light weight and extremely flexible.

It is another object of the present invention to provide a flexible multi-link closure in which the links have tangential line contact resulting in minimal frictional sliding resistance.

### BRIEF SUMMARY OF THE INVENTION

In accordance with one aspect of the present invention, a link of a multi-element flexible closure is provided. The link includes a first member and a second member. The first member has a substantially cylindrical exterior. The second member has an arcuate wall which, in part defines a recess of substantially the same size and shape as the exterior of the first member. Means are provided for connecting the first and second members of the link in a fixed, spaced relationship at a distance substantially equal to the thickness of the wall of the second member.

In accordance with another aspect of the present invention, a flexible closure having a plurality of interconnected links is provided. Each of the links includes a first member and a second member. The first member has a substantially cylindrical exterior. The second member has an arcuate wall, in part defining a recess adapted to moveably receive the first member of an adjacent link. Means are provided for connecting the first and second members of each link in a fixed, spaced relationship at a distance substantially equal to the thickness of the wall of the second member.

In accordance with another aspect of the present invention, an enclosure with an opening is provided. The enclosure has opposing channels extending proximate the sides of the opening. A flexible closure is moveable within the channels to open and close the opening. The closure includes a plurality of interconnected links. Each of the links has a first member and a second member. The first member has a substantially cylindrical exterior. The second member has an arcuate wall, in part defining a recess adapted to moveably receive the first member of an adjacent link. Means are provided for connecting the first member and the second member of each link in a fixed, spaced relationship at a distance substantially equal to the thickness of the wall of the second member. The first member of each link may be solid. However, in order to reduce the weight of the link, it may be preferable to form the first member with a hollow interior.

The wall of the second member has spaced opposing edges. The first member has a center point. The second member has a center point. One of the wall edges is spaced from a line extending through the center points of the members by a distance substantially equal to half the thickness of the wall of the second member.

The edges of the wall of the second member are spaced apart along an arc of at least 45 degrees. Preferably, edges are spaced apart along an arc of approximately 57 degrees.

The connecting means includes a part. The length of the connecting part is substantially equal to the thickness of the wall of the second member. The connecting part extends along a line passing through the center points of the members

### BRIEF DESCRIPTION OF THE SEVERAL VIEWS OF THE DRAWINGS

To these and to such other objects which may hereinafter appear, the present invention relates to a flexible multi-link closure as described in detail in the following specification, recited in the annexed claims and illustrated in the accompanying drawings, wherein like numerals refer to like parts and in which:

FIG. 1 is an isometric view of a utility card with a flexible multi-link closure of the present invention;

FIG. 2 is a cross-sectional view of the corner of the cart of FIG. 1, showing the flexible multi-link closure as it extends around a corner in the guide channel;

FIG. 3 is an end view of a first preferred embodiment of a link of the present invention; and

FIG. 4 is an end view of a second preferred embodiment of a link of the present invention.

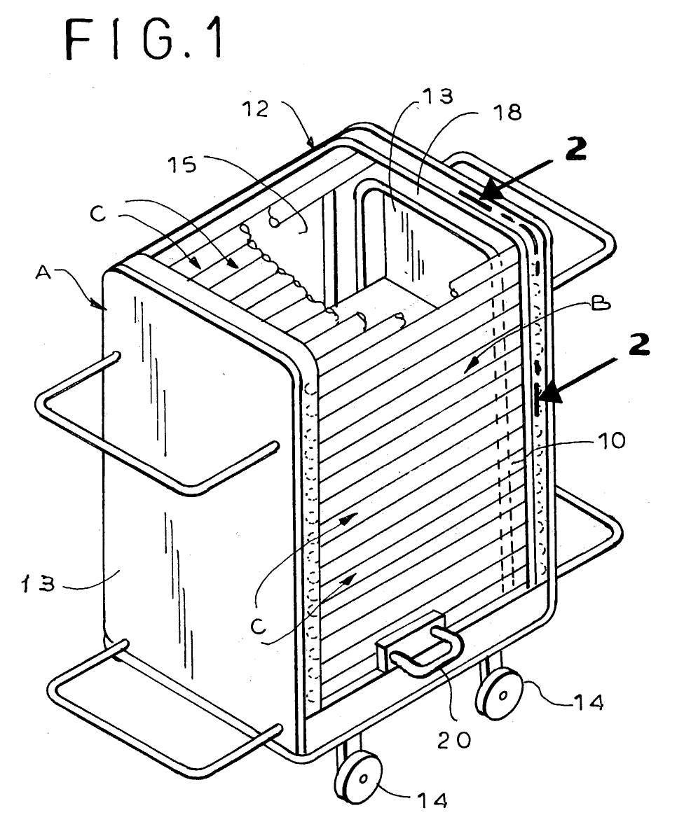

As seen in FIG. 1, the utility cart, generally designated A, is a generally box-like enclosure with an open front 10 and top 12. The sides 13, rear 15 and the bottom of cart A are closed. Cart A is provided with wheels 14 so that it is mobile.

The flexible multi-link closure, generally designated B, formed of a plurality of identical interconnected links, generally designated C, extends between opposing guide channels 16, 18 within which the opposite ends of closure B are moveably received. Closure B moves along channels 16, 18 to open and close the front and top 10, 12 of cart A. A handle 20 is attached to the first link C. Handle 20 facilitates the movement of closure B. A lock (not shown) may be associated with the handle for security purposes.

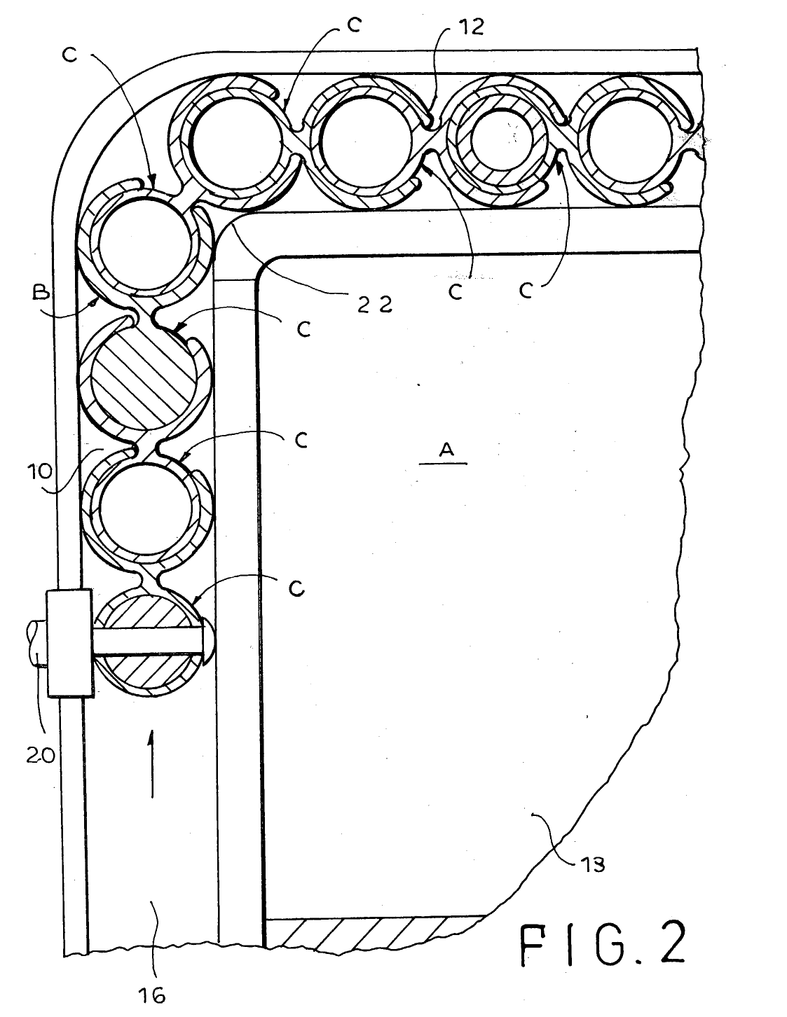

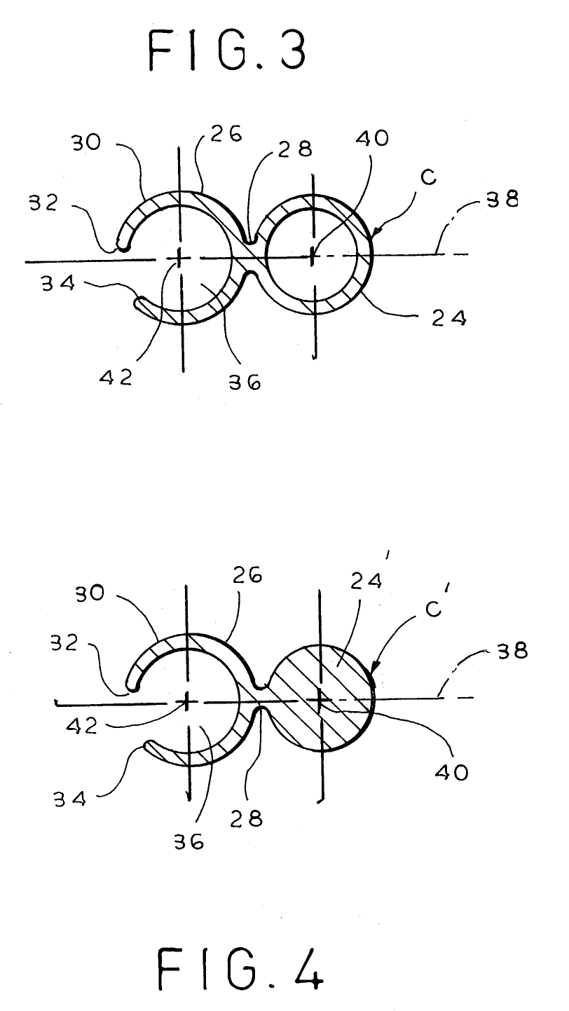

As seen in FIG. 2, the corner 22 of channel 16, between the front 10 and top 12 of cart A, forms a right angle. As the ends of links C move along channels 16 and 18, they move around corner 22. This requires a minimum turning angle, made possible by the unique structure of the links C, as illustrated in FIGS. 3 and 4.

As seen in FIG. 3, each link C consists of a first, male member 24, a second, female member 26 and a part 28 connecting members 24, 26. The male member 24 of each link is moveably received in the female member 26 of the adjacent link, as seen in FIG. 2.

In the embodiment of FIG. 3, member 24 has a generally cylindrical exterior and a hollow interior. Member 26 consists of an open, arcuate wall 30 of substantially uniform thickness, with spaced edges 32, 34. Wall 30 in part defines a cylindrical recess 36 which is the size and shape of the exterior of member 24 such that the member 24 of the adjacent link C can be received the recess defined by wall 30.

Members 24 and 26 of each link C are connected in a fixed, spaced relationship by a part 28. Part 28 is approximately as long as the thickness of wall 30. Thus, the male and female member of each link are spaced apart a distance approximately equal to the thickness of wall 30. This permits the members of each link to be as close together as possible and still allow the edge of wall 30 to fit into the recess adjacent part 28, between members 24 and 26. The closure can therefore move around a tight bend such as a right angle corner with a radius of a little as 1/8 inch, as illustrated in FIG. 2.

Part 28 is located along a line 38 extending between the center point 40 of member 24 and the center point 42 of member 26. The edges 32 and 34 of wall 30 are spaced apart along an arc of at least 45 degrees, but preferably less than 60 degrees. The drawings illustrate an arc of approximately 57 degrees.

Edge 32 of wall 30 is spaced a short distance from line 38. Preferably, edge 32 is spaced from line 38 by a distance approximately equal to one-half of the length of connecting part 36, or of the thickness of wall 30 (which are substantially the same) or about the length of an arc formed by an angle of about 6 degrees. Edge 34 of wall 30 is spaced from line 38 by the length of an arc formed by an angle of about 51 degrees. This configuration permits adjacent links to align in a straight line, such that the closure can move along the straight portions of the guide channels 16, 18.

FIG. 4 illustrates a second preferred embodiment of link C′. Link C′ is identical to link C except that first member 24′ is a solid rod. This configuration is useful in situations where the weight of the closure is not important. In situations where weight is a consideration, a link 24 that is hollow is preferred, as a hollow link is lighter in weight than is solid link.

The links can be made of plastic or metal. The links can be any color desired.

It will now be appreciated that the present invention relates to the structure of a closure link, a flexible closure formed of a plurality of interconnected links and to enclosure with an opening with a moveable flexible closure formed of a plurality of interconnected links.

While only a limited number of preferred embodiments of the present invention have been disclosed herein for purposes of illustration, it is obvious that many variations and modifications could be made thereto. It is intended to cover all of those variations and modifications which fall within the scope of the present invention, as defined by the following claims:

I claim:

1. A link of a multi-link flexible closure comprising a first member and a second member, said first member having a substantially cylindrical exterior, said second member comprising an arcuate wall of a given thickness, in part defining a recess of substantially the same size and shape as said exterior of said first member, and means for connecting said first and second members in a fixed, spaced relationship at a distance substantially equal to said thickness of said wall of said second member.

2. The link of claim 1 wherein said first member is solid.

3. The link of claim 1 wherein said first member has a hollow interior.

4. The link of claim 1 wherein said wall has spaced opposing edges.

5. The link of claim 4 wherein said first member has a center point, said second member has a center point and wherein one of said wall edges is spaced from a line extending through said center points by a distance substantially equal to half of said thickness of said wall of said second member.

6. The link of claim 4 wherein said edges are spaced apart along an arc of at least 45 degrees.

7. The link of claim 4 wherein said edges are spaced apart along an arc of approximately 57 degrees.

8. The link of claim 1 wherein said first member has a center point, said second member has a center point, and wherein said connecting means comprises a part extending along a line through said center points.

9. The link of claim 1 wherein said connecting means comprises a part whose length is substantially equal to said thickness of said wall of said second member.

10. A flexible closure comprising a plurality of interconnected links, each of said links comprising a first member and a second member, said first member having a substantially cylindrical exterior, said second member comprising an arcuate wall of a given thickness, in part defining a recess adapted to moveably receive the first member of an adjacent link and means for connecting said first and second members of each link in a fixed, spaced relationship at a distance substantially equal to said thickness of said wall of said second member.

11. The closure of claim 10 wherein said first member is solid.

12. The closure of claim 10 wherein said first member has a hollow interior.

13. The closure of claim 10 wherein said wall has spaced opposing edges

14. The closure of claim 13 wherein said first member has a center point, said second member has a center point, and wherein one of said wall edges is spaced from a line extending through said center points by a distance substantially equal to half of said thickness of said wall of said second member.

15. The closure of claim 13 wherein said edges are spaced apart along an arc of at least 45 degrees.

16. The closure of claim 13 wherein said edges are spaced apart along an arc of approximately 57 degrees.

17. The closure of claim 10 wherein said first member has a center point, said second member has a center point, and wherein said connecting means comprises a part extending along a line extending through said center points.

18. The link of claim 10 wherein said connecting means comprises a part whose length is substantially equal to said thickness of said wall of said second member.

19. An enclosure comprising an opening, opposing channels extending proximate said opening and a flexible closure moveable within said channels to open and close the opening, said closure comprising a plurality of interconnected links, each of said links comprising a first member and a second member, said first member having substantially cylindrical exterior, said second member comprising an arcuate wall with a given thickness, said wall, in part defining a recess adapted to moveably receive the first member of an adjacent link and means for connecting said first member and said second member of each link in a fixed, spaced relationship at a distance substantially equal to said thickness of said wall of said second member.

20. The enclosure of claim 19 wherein said first member is solid.

21. The enclosure of claim 19 wherein said first member has a hollow interior.

22. The enclosure of claim 19 wherein said wall has spaced opposing edges.

23. The enclosure of claim 22 wherein said first member has a center point, said second member has a center point and wherein one of said wall edges is spaced from a line extending through said center points by a distance substantially equal to half said thickness of said wall of said second member.

24. The enclosure of claim 22 wherein said edges are spaced apart along an arc of at least 45 degrees.

25. The enclosure of claim 22 wherein said edges are spaced apart along an arc of approximately 57 degrees.

26. The enclosure of claim 19 wherein said first member has a center point, said second member has a center point and wherein said connecting means comprises a part extending along a line through said center points.

27. The link of claim 19 wherein said connecting means comprises a part whose length is substantially equal to said thickness of said wall of said second member.
